(19) United States
(12) Patent Application Publication
(10) Pub. No.: US 2005/0265600 A1
(43) Pub. Date: Dec. 1, 2005

(54) SYSTEMS AND METHODS FOR ADJUSTING PIXEL CLASSIFICATION USING BACKGROUND DETECTION

(75) Inventors: Xing LI, Webster, NY (US); Jeng-nan SHIAU, Webster, NY (US); Stuart A. SCHWEID, Pittsford, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/709,833

(22) Filed: Jun. 1, 2004

(51) Int. Cl. G06K 9/00

(52) U.S. Cl. 382/170

(57) ABSTRACT

A pixel classification method for classifying pixels of an image by determining a background intensity level of an image which is based on substantially all of the pixels of the image. The method also involves classifying the pixels of the image and checking the classification of the pixel based on the determined background intensity level of the image.

### BACKGROUND OF THE INVENTION

1. Field of Invention

The present invention relates generally to pixel classification of a scanned image and, more particularly, to using background detection results for adjusting and/or determining the classification of a pixel.

2. Description of Related Art

Image capture devices, such as scanners, and image forming devices, such as copiers, convert the light reflected from an original document into electrical charges that represent the light intensity of predetermined areas, e.g., pixels, of the document. The electrical charges are then processed and signals that can be used to recreate the captured image are generated.

One criteria for evaluating the performance of an image capture device or an image forming device is how well the reproduced image matches the original image. To improve the quality of the reproduced image, multiple steps and considerations are involved during the processing of the captured image data.

For example, to improve the quality of the reproduced image, generally, it is determined what type of image is being represented by the captured image data. Image data is generally stored in the form of multiple scan lines, where each scan line comprises multiple pixels. When processing the image data, it is advantageous to know the type of image represented by the data because it may be advantageous to process each of the image types differently. The image data can represent various types of images including, for example, graphics, text, background, smooth continuous tone (smooth contone), rough continuous tone (rough contone), and halftones of different frequencies. Further, a page of image data can be a single image type or some combination of image types.

To determine the type of image being represented by a pixel and to separate pixels representing different types of images, it is known, for example, to take a page of image data and to separate the image data into windows of similar image types. A page of image data may, for example, include a halftoned picture with accompanying text describing the picture. To efficiently process the image data, the page of the image data may be separated into windows such that a first window represents the halftoned image and the second window represents the text. Processing of the image data is then carried out by customizing the processing based on the type of image data being processed in order to improve the quality of the reproduced image. For example, the image data may be subjected to different filtering mechanisms based on the determined type of the image data.

Accordingly, in order to improve the quality of the reproduced image, it is important for image data to be classified correctly. If the image data is not classified correctly, inappropriate processing may actually diminish the quality of the image data and the reproduced image.

When classifying each pixel individually or when grouping the image data such that each group of pixels (e.g., a window) represents a different type of image data, generally, it is known to make either one or two passes through the page of image data.

In the one pass method, the classification of the pixel is based on the information obtained regarding the pixel during a single pass through the image data, and thus, processing is performed “on the fly” such that pixels are classified after only one or a few scan lines are analyzed. On the other hand, in the two pass method, each pixel is processed and labeled in view of the information obtained after all the pixels have been analyzed. More particularly, in the two pass method, information obtained from the first pass for scan lines processed after the processing of a scan line during the first pass is used to classify the pixels before the second pass during which the image data is processed, based on the determined classifications. For example, in the two pass method, information obtained for a subsequent scan line can be used to generate or correct information for a previous scan line. In some two pass methods, two rounds of pixel level analysis are performed on all the pixels before the pixels are classified while in other two pass methods a single round of pixel level analysis (i.e., a single run through the pixels of the image) is performed before the pixels are classified. U.S. Pat. No. 5,850,474, the entire disclosure of which is incorporated herein by reference, discloses an example of such a two-pass method.

Another example of a step which may be carried out to improve the quality of the reproduced image is determining the contrast of the original image. The contrast of the original image is determined before the captured image data is processed and the determined contrast is used to process the image data. Background detection processes are helpful for determining the contrast of an image. By determining the background of the original document, the background of the captured image can be used to more accurately reproduce the image.

Generally, background detection processes collect light intensity information and use the collected light intensity information to determine an intensity level associated with the document background. The determined intensity level is also referred to as the “background intensity level”. Using the image data of the captured image, statistical analysis, generally a histogram, can reveal a peak which identifies the intensity of a majority of the pixels. The peak may be referred to as a white-peak, a white point or a background peak. The white peak, for example, is the gray level with the greatest number of pixels having an intensity related to the white background of the scanned i mage.

The histogram is also used to determine the gain factor for the document. The gain factor is used to compensate for the background gray level of the image of the scanned document. It should be noted, however, that although the histogram assists in the determination of the background value for the document (page), the background value is only as accurate as the created histogram and the identified peak of the histogram on which it is based.

Conventionally, background detection is performed by sampling pixel values either within a sub-region of the document (typically, the leading edge) or across the whole document. For conventional processes, only a portion (i.e., not the full document) is used to detect the background of the document to be reproduced. The detected lead-edge or other sub-region background information is then used to process and classify each of the pixels of the scanned i mage.

### SUMMARY OF THE INVENTION

In known two-pass methods, for example, the original classification of a pixel as background is done during the first pass using lead-edge or other sub-region information and pixels classified as background during the first pass are not re-classified during the second pass. As lead-edge or other sub-region information may not be a true indication of the background of the captured image, misclassification of pixels as background can occur. For example, a background pixel can be classified as smooth contone or vise versa. Similarly, in known two-pass methods, pixels are subjected to a second pass when the pixel was associated with a “mixed” window during the first pass. Thus, in known classification methods, the classification of a pixel is not reconsidered. However, as discussed above, because it may be advantageous to classify pixels of different image types differently, the misclassification of a pixel as background, for example, can affect background suppression and also the rendering of the types of pixels.

Various exemplary embodiments of the invention provide a pixel classification method for classifying pixels of an image by determining a background intensity level of an image which is based on substantially all of the pixels of the image. The method also involves checking the classification of the pixel based on the determined background intensity level of the image.

Various exemplary embodiments of the invention separately provide a pixel classification apparatus. The pixel classification apparatus includes a background intensity level determining module which determines a background intensity level of an image based on substantially all of the pixels of the image. The pixel classification apparatus also includes an image processing module which classifies a pixel of the image, and checks the classification of the pixel based on the determined background intensity level of the image.

Various exemplary embodiments of the invention separately provide an image processing method. The image processing method determines a background level of an image, based on substantially all of the pixels of the image. The image processing method also classifies a pixel of the image, checks the classification of the pixel based on the determined background intensity level of the image, reclassifies pixels based on the results of the checking step and processes image data based on the classification of the pixel.

### BRIEF DESCRIPTION OF THE DRAWINGS

Various exemplary embodiments of systems and methods of the invention will be described in detail, with reference to the following figures.

FIG. 1 is a diagram illustrating components of an exemplary digital scanner.

FIG. 2 is a block diagram illustrating the electronic architecture of an exemplary digital scanner coupled to a workstation, a network, a storage medium and an image output terminal in accordance with various exemplary embodiments of the invention.

FIG. 3 is a block diagram illustrating an exemplary architecture of an image processing module.

FIG. 4 shows an exemplary two-dimensional look-up table which may be used to classify image data.

FIG. 5 is a block diagram of another exemplary embodiment of an image segmentation module.

FIG. 6 is a flowchart outlining an exemplary two pass segmentation and classification method.

FIG. 7 shows a graphical representation of a scan line of image data.

FIG. 8 shows a graphical representation of scan lines of image data that have been separated into windows.

FIG. 9 is a flowchart outlining an exemplary method for classifying pixels of an image.

### DETAILED DESCRIPTION OF EXEMPLARY EMBODIMENTS

The invention generally relates to methods and systems for adjusting, as necessary, and/or determining the classification of the pixels of a document based on full-page background detection results during capture and out of an image, for example, by a digital scanner. Such a digital scanner is capable of being connected to a wide array of copiers, printers, computers, networks, facsimile machines, and the like, and is capable of scanning and producing complex and interesting images to be stored, printed and/or displayed. The images may include text, graphics, and/or scanned or computer-generated images. With such a scanner, high quality image output can be achieved by automatically determining an image background based on the results of a full-page background detection process and using the image background to dynamically adjust/reclassify, as necessary, or more accurately determine, the classification of a pixel.

It should be understood that various exemplary embodiments of the invention may be used in conjunction with any known pixel classification method in order to adjust, confirm and/or determine the classification of a pixel by using the results of a full-page background detection process for the document. However, for purposes of illustration, exemplary embodiments of classification and/or segmentation processes are described below. Various exemplary embodiments of the invention may be used to adjust and/or confirm the classification of pixels obtained using, for example, the methods described below.

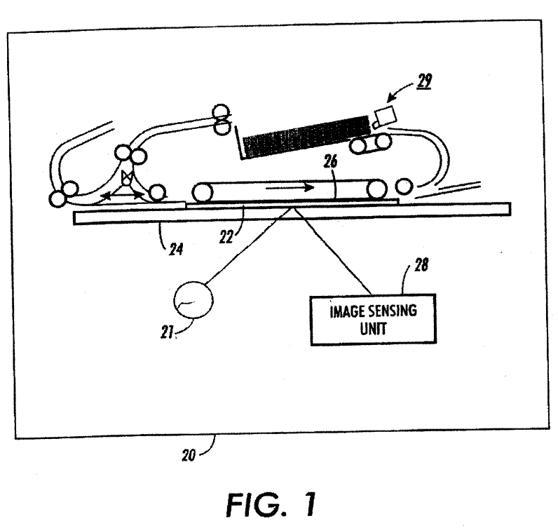

FIG. 1 illustrates components of an exemplary scanning unit 20 of a digital scanner. In the scanning unit 20, a light source 21 is used to illuminate a document 22 to be scanned. In a platen-type scanning situation, the document 22 usually rests upon a glass platen 24, which supports the document 22 for scanning purposes. The document 22 may be placed on the glass platen 24 by an operator. Alternatively, the scanning unit may include a feeder or document handler 29, which places the document on the glass 24.

On top of the glass platen 24 and the document 22, a backdrop portion (platen cover) 26 is placed to prevent stray light from leaving the scanning area to provide a background from which an input document can be distinguished. The backdrop portion 26 may be part of document handler 29. The backdrop portion 26 is the surface or surfaces that can be scanned by an image-sensing unit 28 when a document is or is not present in the scanning station. The light reflected from the document passes through a lens subsystem (not shown) so that the reflected light impinges upon the image sensing unit 28, such as a charge coupled device (CCD) array or a full width array.

A full width array typically comprises one or more linear arrays of photo-sites, wherein each linear array may be sensitive to one or more colors. In a color image capture device, the linear arrays of photo-sites are used to produce electrical signals which are converted to color image data representing the scanned document. However, in a black-and-white scanner, preferably, only one linear array of photo-sites is used to produce the electrical signals that are converted to black and white image data representing the image of the scanned document.

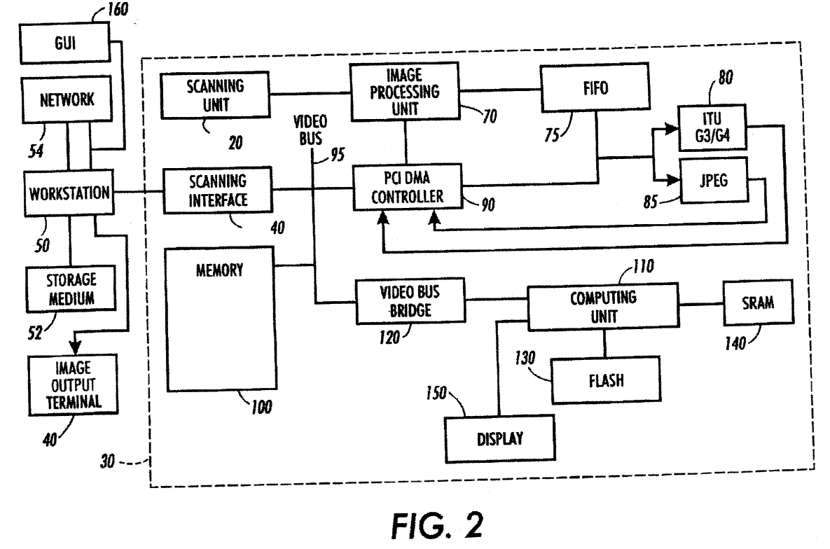

FIG. 2 is a block diagram illustrating the electronic architecture of an exemplary digital scanner 30 including the scanning unit 20. The digital scanner 30 is coupled to a workstation 50 by way of a scanning interface 40. An example of a suitable scanning interface is a SCSI interface. Examples of the workstation 50 include a personal computer or a computer terminal. The workstation 50 includes and/or has access to a storage medium 52. The workstation 50 may be adapted to communicate with a computer network 54, and/or to communicate with the Internet either directly or through the computer network 54. The digital scanner 30 may be coupled to at least one image output terminal (IOT) 60, such as a printing system, via the workstation 50, for example.

The scanning unit 20 scans an image and converts the analog signals received by the image sensing unit 28 into digital signals (digital data). An image processing unit 70 registers each image, and may execute signal correction to enhance the digital signals. As the image processing unit 70 continuously processes the data, a first-in first-out (FIFO) buffer 75 temporarily stores the digital data output by the image processing unit 70, and transmits the digital data, for example, to the International Telecommunications Union (ITU) G3/G4 80 and Joint Photographic Experts Group (JPEG) 85 in bursts, so that the processed data is compressed. Other data compression units may be substituted for the ITU G3/G4 80 and the JPEG 85. The compressed digital data is stored in a memory 100, for example, by way of a Peripheral Component Interconnect Direct Memory Access (PCI/DMA) Controller 90 and a video bus 95. Alternatively, an operator may not wish to compress the digital data. The operator may bypass the compression step so that the data processed by the image processing unit 70 is sent through FIFO 75 and directly stored in the memory 100 by way of the PCI DMA controller 90.

A computing unit 110, such as a microprocessor, is coupled to the scanner interface 40, the memory 100 and the PCI DMA controller 90 by way of the video bus 95 and a video bus bridge 120. The computing unit 110 is also coupled to a flash memory 130, a static RAM 140 and a display 150. The computing unit 110 communicates with the scanning unit 20 and the image processing unit 70, for example, by way of a control/data bus. For example, the computing unit 110 may communicate with the image processing unit 70 through the video bus 95 and/or the PCI DMA controller 90. Alternatively, the computing unit 110 may communicate directly with different components, such as the image processing unit 70 by way of control/data buses (not shown).

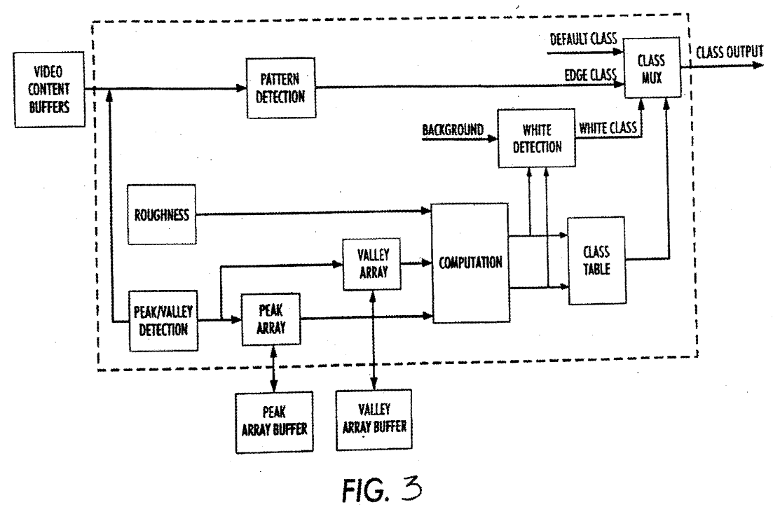

FIG. 3 shows an exemplary architecture of an image segmentation apparatus 300 which may form part of the image processing unit 70 shown in FIG. 2.

FIG. 3 shows two exemplary features that may be extracted and used for image processing and/or segmentation in order to improve the quality of the reproduced image. The two features are video peak/valley count within a window containing the pixel being classified and local roughness.

Local roughness may represent the degree of gray level discontinuity computed as a combination of some gradient operators. One example of local roughness is the difference between the maximum and minimum of nine 3×3 window sums within a 5×5 video context. It should be understood that various exemplary embodiments of the invention may be used in conjunction with any known or hereafter developed methods of determining the local roughness.

On the other hand, a pixel may be considered as a video peak or video valley, respectively, if its gray level is the highest or the lowest in a neighborhood and the gray level difference between the gray level of the pixel and the gray level of the neighborhood average is greater than a certain threshold. It should be understood that various exemplary embodiments of the invention may be used in conjunction with any known or hereafter developed methods for determining video peaks and/or video valleys.

Several lines of peak and valley patterns may be recorded in scan line buffers for computing peak/valley count within a defined window. For example, various exemplary embodiments of the invention may be used in a system where the peak/valley count and local roughness are used as indices to form a two-dimensional look-up table (hereafter also called a classification table) as a basis to classify image data.

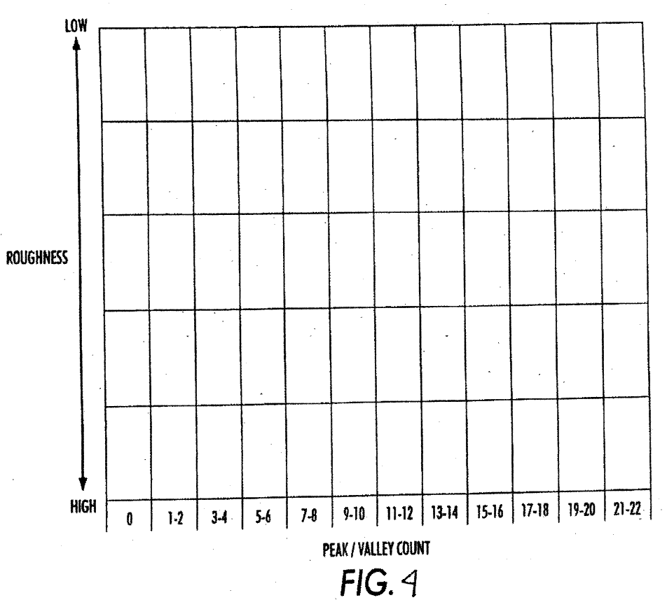

FIG. 4 shows an example of a two-dimensional look up table that uses five roughness levels and twelve peak/valley count levels. As a result, the look up table includes sixty classification table entries (i.e., 5×12=60). Depending on a location within the look-up table, the video data may be mapped to certain classifications such as low frequency halftone, high frequency halftone, smooth continuous tone, rough continuous tone, edge, text on halftone, and the like. Depending on the classification, the input data may be processed differently. For example, different filters may be applied, based on the classification, during processing of the data in order to improve the overall quality of the reproduced image.

Various exemplary embodiments of the invention may be used in conjunction with a system in which the look-up table (i.e., classification table) is complemented with some special classifications. One example of a possible special classification is the “edge classification”. The “edge classification” tries to identify some line art and kanji area that could be missed by the look-up table. Another example of a special classification is the “white classification”. The “white classification” makes use of the absolute gray level information in addition to peak/valley count and roughness. A “default classification” may be used for the borders of an image. The classification look-up table output may be multiplexed with the special classification to produce the final classification of a pixel (i.e., classification output). The classification table assignment may be programmable to allow for more flexibility in rendering adjustment.

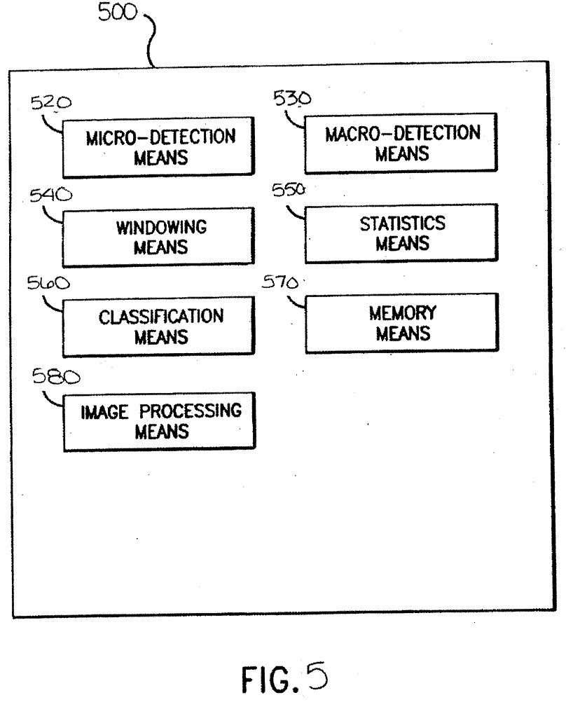

FIG. 5 shows a block diagram of a page segmentation and classification apparatus 500 as another example of a portion of the image processing unit 70 shown in FIG. 2. The page segmentation and classification apparatus 500 performs a two-pass segmentation and classification method. The page segmentation and classification apparatus 500 includes micro-detection means 520 for performing a micro-detection step, macro-detection means 530 for performing a macro-detection step and windowing means 540 for grouping image runs of the scan lines together to form windows. The apparatus 500 also includes statistics means 550 for gathering and calculating statistics regarding the pixels within each window and classification means 560 for classifying each of the windows as a particular image type based on the gathered statistics.

Memory means 570 is provided for recording the beginning points and image types of each of the windows and the beginning points and image types of any initially unknown image runs that are subsequently classified during the first pass. The memory means 570 may also be used to store the window and image type of each pixel at the end of the second pass. Typically, however, the image data is used immediately to process, transmit and/or print the image, and the image data is then discarded.

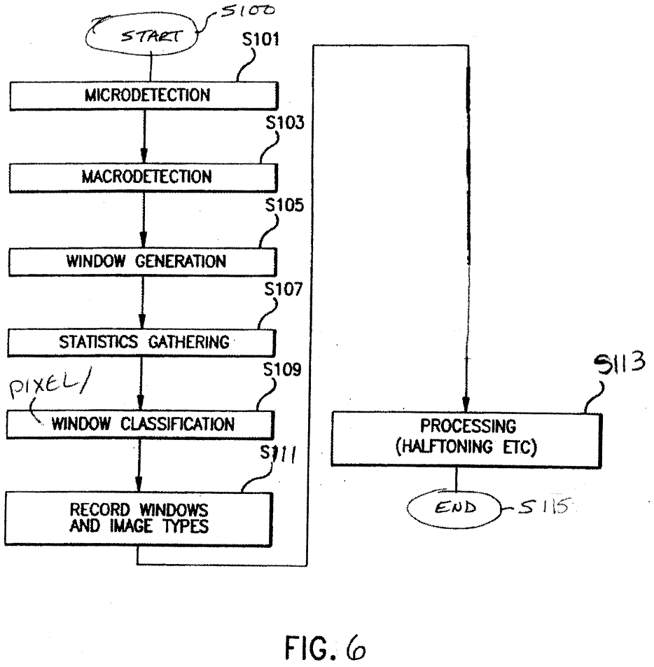

FIG. 6 shows a block diagram illustrating an exemplary two pass segmentation and classification method which may be performed using the apparatus 500 shown in FIG. 5. The two pass segmentation and classification method may be used in conjunction with various exemplary embodiments of the invention. The method segments a page of image data into windows, classifies the image data within each window as a particular image type and records information regarding the window and image type of each pixel. Once the image type for each window and/or pixel is known, further processing of the image data can be efficiently performed during the second pass. For example, during the second pass, when the image data is being processed, different filters may be applied to different pixel classes in order to improve the quality of the reproduced image.

As discussed above, the image data comprises multiple scan lines of pixel image data and each scan line typically includes intensity information for each pixel within the scan line. Typical image types include graphics, text, low-frequency halftone, high frequency contone, and the like.

Control begins in step S100 and continues to step S107. In step S101, micro-detection is carried out. During micro-detection, multiple scan lines of image data are buffered into memory. Each pixel is examined and a preliminary determination is made as to the image type of the pixel. In addition, the intensity of each pixel is compared to the intensity of its surrounding neighboring pixels. A judgment is made as to whether the intensity of the pixel under examination is significantly different than the intensity of the surrounding neighboring pixels. When a pixel has a significantly different intensity than its neighboring surrounding pixels, the pixel is classified as an edge pixel.

Next in step S103, macro-detection is performed. The results of the micro-detection step are used to identify those pixels within each scan line that are edges and those pixels that belong to image runs. The image type of each image run is then determined based on the microdetection results. The image type of an image run may also be based on the image type and a confidence factor of an adjacent image run of a previous scan line. If information obtained during an image run of a previous scan line is not sufficient to classify the image run as a standard image type, but information generated during examination of the current scan line makes it possible to determine the image type of the image run of the previous scan line, the determination of the image type of that image run is made. The image type of the image run of the previous scan line is then recorded.

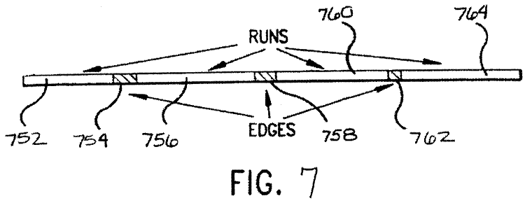

An example of a single scan line of image data is shown in FIG. 7. During the macro-detection step, adjacent pixels having significantly different intensities from each other are classified as edges 754, 758 and 762. Portions of the scan line between the edges are classified as image runs 752, 756, 760 and 764. It should be understood that although the micro-detection step S101 and the macrodetection step S103 of the exemplary segmentation method are shown sequentially, it is possible to carry out the steps simultaneously.

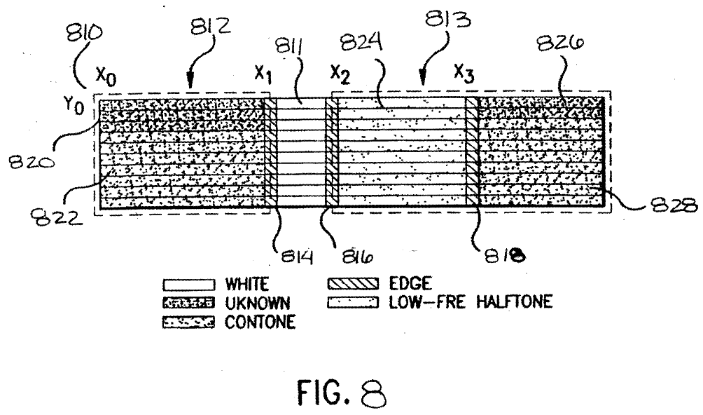

Next in step S105, the image runs of adjacent scan lines are combined to form windows. It should be understood that the term windows may be applied to portions of the scanned image which contain similarly classified pixels or portions of the obtain image which are connected. A graphical representation of multiple scan lines that have been grouped into windows is shown in FIG. 8. The image data has been separated into a first window 812 and a second window 813, separated by a gutter 811. A first edge 814 separates the first window 812 from the remainder of the image data. A second edge 816 separates the second window 813 from the remainder of the image data. In addition, a third edge 818 separates the second window 813 into a first portion 824 and a second portion 826 each having different image types.

Next in step S107, statistics are gathered and calculated for each of the windows and the pixels of the scanned image. The statistics are based on the intensity and macrodetection results for each of the pixels within a window.

Next in step S109, the statistics are examined to classify each window and each pixel of the scanned image.

At the end of the first pass, in step S111, the beginning point and the image type of each of the windows and/or the classification tag of each pixel are recorded.

Next in step S113, the pixels classifications are used to process the image data accordingly. For example, during processing of the image data, different filters may be applied to the data based on the classification of the pixel being processed. Control proceeds to step S115 where the process ends.

As discussed above, various exemplary embodiments of the invention may be used in conjunction with any known or hereafter developed image segmentation and/or pixel classification systems and methods, such as, the exemplary systems and methods described above. Irrespective of the system or method used, each pixel of a scanned image is generally classified into one of several types of classes, such as, text, background, smooth contone, rough contone, halftones of different frequencies, and the like. Various exemplary embodiments of the invention use full-page background detection results to challenge the classification of a pixel and to adjust/reclassify, as necessary, the classification of the pixel.

It should be understood that preferably, in various exemplary embodiments of the invention, the full-page background detection results may be used to check the classification of a pixel prior to the labeling of the pixel.

Various exemplary embodiments of the invention may be incorporated into the exemplary segmentation and processing method described above. In particular, various exemplary embodiments of the invention use the results of a full page based background detection to adjust, as necessary, the classification of the pixels by checking the classification. Various exemplary embodiments of the invention check the classification of a pixel by comparing the intensity of the pixel with the intensity of the white point or the background intensity level of the image. The white point or the background intensity level of the image is determined based on an analysis of substantially all of the pixels of the document, and not just a sampling of the pixels or a sub-region of the image.

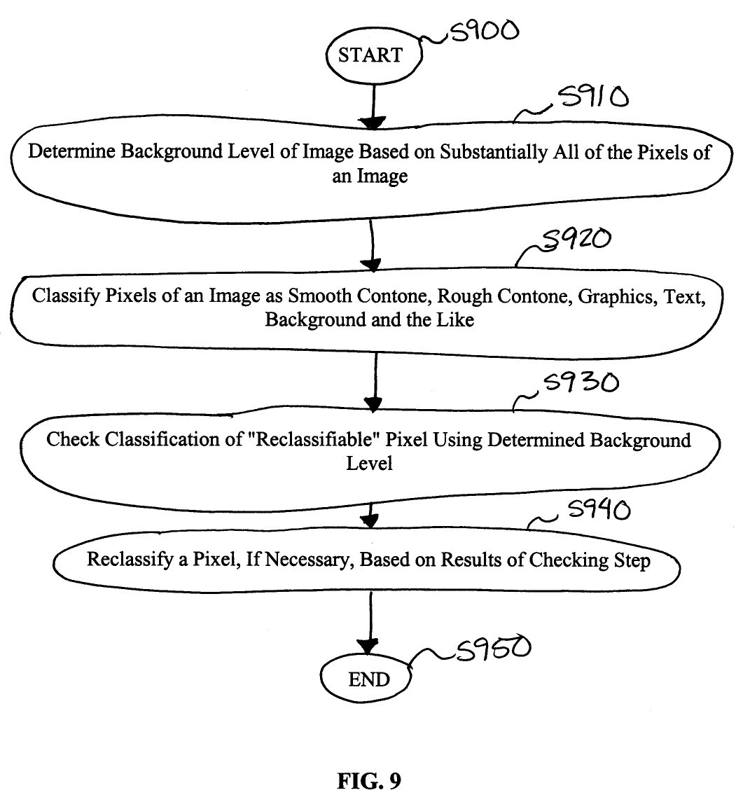

FIG. 9 is a flowchart outlining an exemplary method for classifying pixels of an image. It should be understood that although the steps are illustrated sequentially, the various steps may occur simultaneously and/or in any order.

Control begins in step S900 and continues to step S910. In step S910, the background intensity level of the image is determined. As discussed above, the background intensity level is based on substantially all of the pixels of the image. Next, in step S920, the pixels of the image are classified. Then, in step S930, the classification of each pixel is checked based on the determined background intensity level of the image. More particularly, in step S930 the classification of pixels classified as a pixel class eligible for reclassification, such as smooth contone and background, are checked.

When, for example, the intensity of a pixel classified as background is less than the intensity of a determined white point of the image, the pixel is reclassified as smooth contone in step S940. Conversely, when, for example, the intensity of a pixel is classified as background is not less than the intensity of a determined white point of the image, the pixel's classification is confirmed as background and is not modified.

When, for example, the intensity of a pixel classified as smooth contone is not less than the intensity of the white point of the image, the pixel is reclassified as background in S940. Conversely, when, for example, the intensity of a pixel is classified as smooth contone is less than the intensity of a determined white point of the image, the pixel's classification is confirmed as smooth contone and is not modified.

In various exemplary embodiments of the invention, various contone based classes, such as, rough contone and smooth contone, are eligible for classification and can be subjected to re-classification based on the background detection results of the scanned image.

In some exemplary embodiments of the invention that are used in conjunction with systems and methods where micro-level classification is followed by macro-level classification (i.e., for example, image objects or “windows” are identified and classified, as described above), the classification of any or all of the pixels in both the non-window and window areas may be checked and adjusted, if necessary. That is, the results of a full page based background detection may be used to adjust, as necessary, the classification of any and/or all of the pixels.

In various exemplary embodiments of the invention, full-page based background detection results are used to check/adjust the classification of pixels for monochrome images and/or color images. Various exemplary embodiments of the invention provide a method for classifying pixels in which misclassification of a pixel can be substantially and preferably, completely eliminated. For example, the misclassification of a pixel as a background pixel instead of a smooth contone may be substantially and preferably, completely eliminated.

It should be understood that the computing unit 110, may be any known system capable of processing the data, such as, a special purpose computer, a programmed microprocessor or micro-controller and peripheral integrated circuit elements, an ASIC or other integrated circuit, a hardwired electronic or logic circuit such as a discrete element circuit, a programmable logic device such as a PLD, PLA, FPGA or PAL, or the like. Specific algorithms may also be accomplished using software in combination with specific hardware.

While the invention has been described with reference to various exemplary embodiments disclosed above, various alternatives, modifications, variations, improvements and/or substantial equivalents, whether known or that are or may be presently unforeseen, may become apparent upon reviewing the foregoing disclosure. Accordingly, the exemplary embodiments of the invention, as set forth above, are intended to be illustrative, not limiting. Various changes may be made without departing from the spirit and scope of the invention.

1. A pixel classification method, comprising:
determining a background intensity level of an image, the background intensity level being based on substantially all of the pixels of the image;
classifying a pixel of the image; and
checking the classification of the pixel based on the determined background intensity level of the image.

2. The pixel classification method of claim 1, wherein the determining step comprises determining a white point of the image based on at least one characteristic of substantially all of the pixels of the image.

3. The pixel classification method of claim 2, wherein the checking step comprises comparing an intensity of the pixel with an intensity of the white point of the image.

4. The pixel classification method of claim 3, further comprising reclassifying the pixel as background when the pixel is classified as a class eligible to be reclassified and the intensity of the pixel is not less than the intensity of the white point of the image.

5. The pixel classification method of claim 3, further comprising reclassifying the pixel as one of smooth contone and an equivalent class when the pixel is classified as background and the intensity of the pixel is less than the intensity of the white point of the image.

6. The pixel classification method of claim 1, wherein the determining step comprises identifies a spread of intensity levels of substantially all the pixels of the image and determining an intensity level of a majority of the pixels.

7. The pixel classification method of claim 4, wherein the pixel is classified as smooth contone.

8. A pixel classification apparatus, comprising:
a background intensity level determining module that determines a background intensity level of an image based on substantially all of the pixels of the image; and
an image processing module that classifies a pixel of the image, and checks the classification of the pixel based on the determined background intensity level of the image.

9. The pixel classification apparatus of claim 8, wherein the background intensity level determining module determines a white point of the image based on a characteristic of substantially all of the pixels of the image.

10. The pixel classification apparatus of claim 9, wherein the image processing module checks the classification of the pixel by comparing the intensity of the pixel with the intensity of the white point of the image.

11. The pixel classification apparatus of claim 10, wherein when a pixel is classified as a class eligible to be reclassified and the intensity of the pixel is not less than the intensity of the white point of the image, the pixel is reclassified as background.

12. The pixel classification apparatus of claim 10, wherein when a pixel is classified as background and the intensity of the pixel is less than the intensity of the white point of the image, the pixel is reclassified as smooth contone.

13. The pixel classification apparatus of claim 1, wherein the image processing module identifies a spread of intensity levels of substantially all the pixels of the image and determines an intensity level of a majority of the pixels.

14. The pixel classification apparatus of claim 11, wherein the pixel is classified as one of smooth contone and an equivalent class.

15. An image processing method, comprising:
determining a background intensity level of an image, the background level being based on substantially all of the pixels of the image;
classifying a pixel of the image;
checking the classification of at least a portion of the pixels of the image based on the determined background intensity level of the image;
reclassifying pixels based on results of the checking step; and
processing image data of the pixels of the image based on the classification of the pixels.

16. The image processing method of claim 15, further comprising storing a label associated with each of substantially all of the pixels, wherein the label of each of substantially all of the pixels is based on results of the classification step and the checking step for the pixel.

17. The image processing method of claim 15, wherein classifying a pixel of the image comprises classifying the pixel as one of smooth contone, rough contone, text, background, graphics and halftone.

18. The image processing method of claim 15, wherein the determining step comprises determining a white point of the image based on a characteristic of substantially all of the pixels of the image.

19. The image processing method of claim 18, wherein the checking step comprises comparing an intensity of the pixel with an intensity of the white point of the image.

20. The image processing method of claim 19, wherein when the pixel is classified as smooth contone and the intensity of the pixel is not less than the intensity of the white point of the image, the pixel is reclassified as background.

21. The image processing method of claim 19, wherein when the pixel is classified as background and the intensity of the pixel is less than the intensity of the white point of the image, the pixel is reclassified as smooth contone.

22. The image processing method of claim 15, wherein the portion of the pixels comprises substantially all of the pixels of the image.
